(19) United States
(12) Patent Application Publication
(10) Pub. No.: US 2017/0076271 A1
(43) Pub. Date: Mar. 16, 2017

(54) SYSTEM FOR OPENING AND CONSOLIDATING ACCOUNTS BASED ON AN EVENT ASSOCIATED WITH THE ACCOUNT HOLDER

(71) Applicant: BANK OF AMERICA CORPORATION, Charlotte, NC (US)

(72) Inventors: Alicia C. Jones-McFadden, Fort Mill, SC (US); Cameron Darnell Wadley, Waxhaw, NC (US); Katherine Dintenfass, Charlotte, NC (US); Angela Fritz Thompson, Matthews, NC (US); Damon C. Missouri, Trenton, NJ (US); Alexander C. Wittkowski, Charlotte, NC (US)

(21) Appl. No.: 14/851,769

(22) Filed: Sep. 11, 2015

(51) Int. Cl. G06Q 20/22; G06F 17/30

(52) U.S. Cl. CPC G06Q 20/227; G06F 17/30368; G06F 17/3097

(57) ABSTRACT

Systems, computer program products, and methods are described herein for analyzing financial accounts of users, providing suggested financial actions, and automatically taking the financial actions by transforming the financial accounts or transactions of the users based on a life event of the users. Typically, the life event may be a marriage or a divorce. The occurrence of a life event may be determined by the transactions that users make, social network postings made by users, input into an application made by users, or like. After the determination of an occurrence of a life event, the finances of the users associated with the life event are analyzed and suggested financial actions are determined. The analysis of the finances and one or more proposed financial actions are presented to the users. A user selects one or more of the financial actions to implement and the proposed financial action is automatically initiated.

### FIELD

The present invention relates to systems for analyzing and then transforming user financial information in view of a life event, more particularly the present invention analyzes financial accounts of users before getting married or divorced, recommending financial actions for the users' financial accounts and transactions, and transforming the financial accounts for the users automatically.

### BACKGROUND

Customers of financial institutions have little guidance on how their finances change when a major life event occurs. For example, when getting married or divorced customers are often unsure of the options for altering, combining, splitting, or opening new financial accounts, and/or taking other financial actions that would benefit the customers.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for analyzing financial accounts of users, providing suggested financial actions, and automatically taking the financial actions by transforming the financial accounts or transactions of the users based on a life event of the users. The life-event may be an event that has occurred in the past, but more typically the life event is a life-event that may occur in the future. Typically, the life event may be a marriage, a separation, a divorce, co-habitation or living apart, birth of a child, a child going to college, retirement or the like. The occurrence of a life event may be determined by the transactions that users make, social network postings made by users, input into an application made by users, or like. After the determination of an occurrence of a life event, the finances of the users associated with the life event are analyzed and suggested financial actions are determined. The analysis of the finances and one or more proposed financial actions are presented to the users. A user selects one or more of the financial actions to implement and the proposed financial action(s) are automatically initiated, such as transforming the financial accounts into a different type of account, providing a new insurance plan for the user, transferring funds from savings accounts of both users into investments accounts, or the like.

Embodiments of the invention includes systems, computer implemented methods, computer program products, or the like for providing recommended financial actions for finances of users based on life events of the users. The invention includes determining a life event occurrence, wherein the life event may include a past life event or a future life event; determining a second user associated with the life event of the first user; accessing financial accounts of the first user and the second user associated with the life event, through the financial institution systems or third-party systems; analyzing the finances of the first user and the second user from the financial accounts; determining suggested financial actions for the first user and the second user, wherein the suggested financial actions comprise pre-event financial actions or post-event financial actions; displaying the suggested financial actions to the first user and the second user in a user interface, through the first user computer system and the second user computer system; receiving an indication from the first user and the second user to take at least one suggested financial action from the suggested financial actions, wherein the at least one suggested financial action comprises transforming at least one financial account from the financial accounts into a different account type or creating a new financial account and transferring the assets of at least one of the financial accounts of the first user or the second user into the new account; and applying the suggested financial action, wherein applying the suggested financial action comprises automatically transforming the at least one financial account into the different account type or creating the new financial account and transferring the assets of at least one of the financial accounts of the first user or the second user into the new financial account.

In further accord with an embodiment of the invention, the life event comprises a marriage or a divorce between the first user and the second user.

In another embodiment, the invention comprises receiving an image of a certificate of marriage or certificate of divorce; capturing information from the image, wherein the captured image indicates the occurrence of the life event or indicates the second user associated with the life event.

In still another embodiment, the invention comprises prompting first user to verify that the life event occurred; receiving conformation from the first user that the life event occurred; and wherein applying the suggested financial action occurs after the life event has been verified.

In yet another embodiment, the invention comprises automatically designate the second user as a beneficiary of the financial accounts of the first user when the life event is the marriage, or automatically remove the second user as the beneficiary of the financial accounts of the first user when the life event is the divorce.

In further accord with an embodiment, the invention comprises automatically designating the second user for power of attorney when the life event is the marriage or automatically removing the second user for power of attorney when the life event is the divorce.

In another embodiment, the invention comprises monitoring if the first user and the second user applied the suggested financial actions over a time period, and prompting the first user or the second user to apply another suggested financial action.

In still another embodiment of the invention, the determination of the life event comprises monitoring transaction information of the first user account through the financial institution systems; and identifying the transaction information indicating the life event.

In yet another embodiment of the invention, the determination of the life event comprises monitoring social networking information from a user social networking account of the first user, through the social networking systems; and identifying social networking information indicating the life event.

In further accord with an embodiment, the invention comprises creating a plurality of financial models, wherein each of the plurality of financial models comprise different combinations of the suggested financial actions; wherein displaying the suggested financial actions comprises displaying the plurality of financial models in the one or more interfaces; and receiving a selection of one of the plurality of financial models from the first user or the second user to implement.

In another embodiment, the invention comprises receiving a selection of a plurality of financial actions from the suggested financial actions to implement; determining a financial model based on the selection of the plurality of financial actions and display the financial model in the one or more interfaces to the first user and the second user.

In still another embodiment of the invention, the suggested financial actions are suggested financial actions to take before the occurrence of the life event.

In yet another embodiment of the invention, the suggested financial actions are suggested financial actions to take after the occurrence of the life event.

In further accord with an embodiment, the invention comprises requesting access to the financial accounts of the first user and the second user; and receiving allowance from the first user and the second user to access the financial accounts of the first user and the second user at other financial institutions.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a life event system environment, in accordance with one embodiment of the invention.

FIG. 2 illustrates a high level process flow of a life event financial planning process, in accordance with one embodiment of the invention.

FIG. 3 illustrates a detailed process flow of a life event user finances analysis process, in accordance with one embodiment of the invention.

FIG. 4 illustrates a user financial analysis interface, in accordance with one embodiment of the invention.

FIG. 5 illustrates a suggested financial action interface, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout. As such, methods, systems, computer programs, and the like, are herein disclosed that provide for a financial wellness application for transforming customer information into useable information for determining the financial wellness of the customer and actionable items for improving the financial wellness.

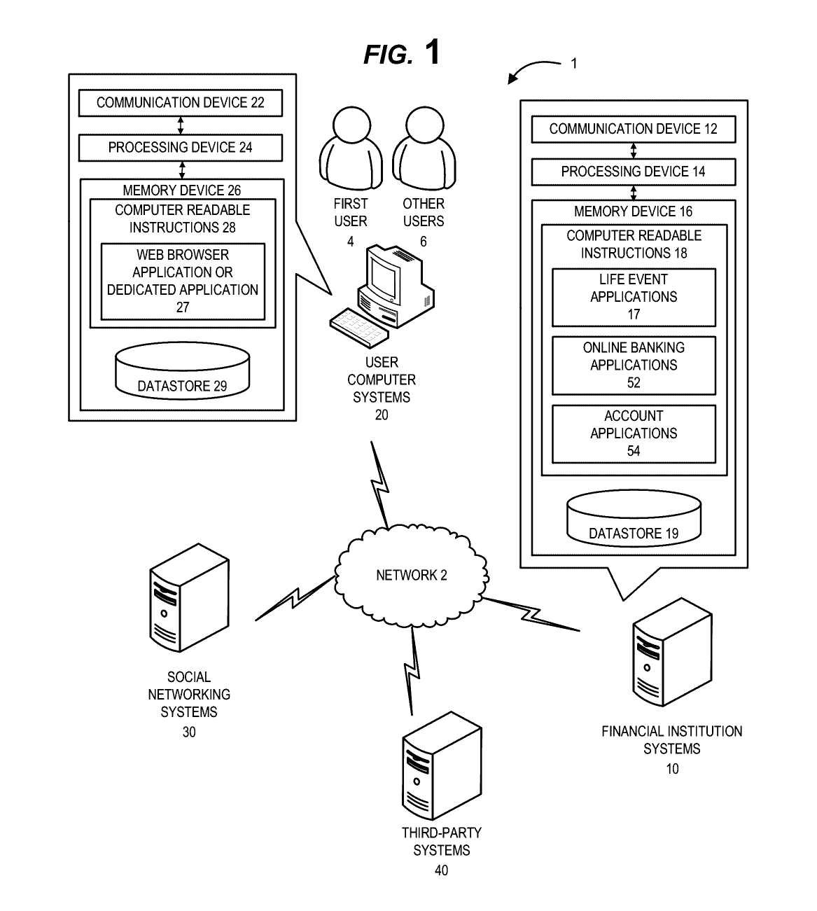

FIG. 1 illustrates an life event system environment 1, in accordance with an embodiment of the present invention. As illustrated in FIG. 1, one or more financial institution systems 10 are operatively coupled, via a network 2, to one or more user computer systems 20 (e.g., first user computer systems, second user computer systems, or other user computer systems), one or more social networking systems 30, and/or one or more third-party systems 40. In this way, the first user 4 (e.g., customer of the financial institution, or the like) and the other users 6 (e.g., the second user 6, or the like which may or may not be customers of the financial institution) may utilize the one or more user computer systems 20 to access the financial institution applications, such as the life event application 17, the online banking application 52, the account application 54, or other like applications of the financial institution in order to determine how a life event effects the user's finances (e.g., the user's financial planning, the user's financial accounts, the transactions related to the financial accounts, or the like).

In some embodiments of the invention the one or more financial institution systems 10 may store user profile information, account information, financial information, transaction history, or the like about the users 4, 6, that are customers of the financial institution or associated with customers of the financial institutions. As such, the financial institution may monitor when the users 4, 6 have a life event and propose changes to the users' finances, including the user's financial accounts, in order to put the users' in a better financial position, to satisfy the financial requests of the users 4, 6, or comply with regulations.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, and/or devices on the network 2.

As illustrated in FIG. 1, the financial institution systems 10 generally comprise one or more communication devices 12, one or more processing devices 14, and one or more memory devices 16. The one or more processing devices 14 are operatively coupled to the one or more communication devices 12 and the one or more memory devices 16. As used herein, the term “processing device” generally includes circuitry used for implementing the communication and/or logic functions of a particular system. For example, a processing device 14 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The one or more processing devices 14 may include functionality to operate one or more software programs based on computer-readable instructions 18 thereof, which may be stored in the one or more memory devices 16.

The one or more processing devices 14 use the one or more communication devices 12 to communicate with the network 2 and other devices on the network 2, such as, but not limited to, the user computer systems 20, the account systems 30, third-party systems 40, or other like systems. As such, the one or more communication devices 12 generally comprises a wireless transceiver, modem, server, electrical connection, or other device for communicating with other devices on the network 2. The one or more communication devices 12 may further include an interface that accepts one or more network interface cards, ports for connection of network devices, Universal Serial Bus (USB) connectors and the like.

As further illustrated in FIG. 1, the financial institution systems 10 comprise computer-readable instructions 18 stored in the memory device 16, which in one embodiment includes the computer-readable instructions 18 of a life event application 17, online banking applications 52, account applications 54, or other applications. In some embodiments, the one or more memory devices 16 include one or more datastores 19 for storing data related to the financial institution systems 10, including, but not limited to, data created and/or used by the life account application 17, online banking applications 52, account applications 54, or other applications.

The life event application 17 may be a tool, website, mobile device app, other computer system app, or the like that is used to allow the user to view, receive, or input information related to user finances that are based on a life event. For example, as discussed in further detail later the life event application 17 may allow the users 4, 6 to view financial information summaries for users associated with a life event, receive suggested financial actions regarding how the users 4, 6 should make financial decisions regarding user finances, such as but not limited to account ownership, account types, refinancing, investment accounts, insurance payments, asset and liability actions (e.g., selling, paying down, transferring ownership, or the like), or other like finances before and/or after the life event occurs. The online banking application 52 and/or the account applications 54 may allow the users 4, 6, or representatives of the financial institution, to view information about the users' finances, including the users' financial accounts.

As illustrated in FIG. 1, users 4, 6 may access the life event application 17, or other financial institution applications, through a user computer system 20. The user computer system 20 may be a desktop, laptop, tablet, mobile device (e.g., smartphone device, or other mobile device), or any other type of computer that generally comprise one or more communication devices 22, one or more processing devices 24, and one or more memory devices 26.

The one or more processing devices 24 are operatively coupled to the one or more communication devices 22, and the one or more memory devices 26. The one or more processing devices 24 use the one or more communication devices 22 to communicate with the network 2 and other devices on the network 2, such as, but not limited to, the financial institution systems 10, the social networking systems 30, the third-party systems 40, and/or other systems not specifically illustrated. As such, the one or more communication devices 22 generally comprise a wireless transceiver, modem, server, electrical connection, or other device for communicating with other devices on the network 2. The one or more communication devices 12 may further include an interface that accepts one or more network interface cards, ports for connection of network devices, Universal Serial Bus (USB) connectors and the like. Moreover, the one or more communication devices 12 may include a keypad, keyboard, touch-screen, touchpad, microphone, mouse, joystick, other pointer device, button, soft key, and/or other input device(s) for communicating with the users 4, 6.

As illustrated in FIG. 1, the user computer systems 20 may have computer-readable instructions 28 stored in the one or more memory devices 26, which in one embodiment includes the computer-readable instructions 28 of a web browser application or another dedicated application 27 that allows the users 4, 6 to access the life event applications 17, or other financial institution applications, or receive information (e.g., financial summaries, suggested financial actions, or the like) from the life event applications 17, or other financial institution applications, or access or received information from other applications, such as applications on the social networking systems 30 (e.g., social networking applications) or third-party systems 40 (e.g., applications from other financial institutions, or the like). In some embodiments, the one or more memory devices 26 include one or more datastores 29 for storing data related to the client computer systems 20, including but not limited to data created and/or used by the web browser/application 27. The web browser/application 27 may be utilized by the user 4 to access the life event applications 17, or other financial institution applications, or receive information the life event applications 17, or other financial institution applications, to view and/or access a financial planning information (e.g., suggestions to take with respect to financial accounts or other assets or liabilities, or the like). The web browser may be an application that allows the users 4, 6 to access websites over a distributed network of systems (e.g., servers), such as the Internet or an intranet. The application may be a dedicated application for a computer or mobile device that allows the users 4, 6 to access information over the distributed network of systems (e.g., servers), such as the Internet or an intranet.

As illustrated in FIG. 1, the social networking systems 30 are operatively coupled to the financial institution systems 10, user computer systems 20, third-party systems 40, or the like, through the network 2. The social networking systems 30 have devices the same as or similar to the device described with respect to the financial institution systems 10 and/or user computer systems 20 (e.g., one or more communication devices, one or more processing devices, and one or more memory devices with computer-readable instructions, one or more datastores, or the like). Thus, the social networking systems 30 communicate with the financial institution systems 10, the user computer systems 20, and the third-party systems 30, and/or each other in same or similar way as previously described with respect to the financial institution systems 10 and/or the user computer systems 20. The social networking systems 30, in some embodiments, may include a social networking application, through which the users 4, 6 and/or the financial institution systems 10 may access the user's social networking accounts and information. For example, in one embodiment the financial institution systems 10 may access the social networking accounts of the users 4, 6, in order to determine when the users 4, 6 have been involved in a life event, as described in further detail later.

The third-party systems 40 (e.g., other financial institution systems, merchant systems, other entity systems) are operatively coupled to the financial institution systems 10, user computer systems 20, and social networking systems 30, through the network 2. The third-party systems 40 have devices the same as or similar to the devices described for the financial institution systems 10 and the user computer systems 20 (e.g., one or more communication devices, one or more processing devices, one or more memory devices with computer-readable instructions, one or more datastores, or the like). Thus, the third-party systems 40 communicate with the financial institution systems 10, the user computer systems 20, and the social networking systems 30, and/or each other in the same or similar way as previously described with respect to the financial institution systems 10, the user computer systems 20, and the account systems 30. The third-party systems 40, in some embodiments, provide additional information about the users 4, 6 such as but not limited to user profile information, the user's assets and liabilities, the user's investments, the user's transactions, or the like that stored by other financial institutions, merchants, or entities, which may be used by the life event application 17, or the like.

In some embodiments of the invention one or more of the systems may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the life event application 17 may be stored on the user computer systems 20, or may be included as a portion of the online banking applications 52, in order to achieve the invention described herein.

It should be understood, that the systems described in FIG. 1 may be configured to establish a communication link with each other in order to accomplish the steps of the processes described herein. The link may be an internal link within the same entity (e.g., within the same financial institution) or a link with the other entity systems described herein (e.g., social networking systems, third-party systems, or the like). In some embodiments, the systems may be configured for selectively monitoring accounts of multiple users on different systems. These feeds of account data can be provided via wireless network path portions through the Internet. When the system is not monitoring a source, the data need not be transmitted from the source to the Internet, although it could be. The sources of data may be made continuously available, however, continuously available does not necessarily mean that the sources actually continuously generate data, but that a source is continuously available to generate and send data real-time (i.e., within a few seconds, or the like) of receiving a request for it. In any case, the sources are continuously available to generate data, in some cases in digitized data in Internet Protocol (IP) packet format. In response to continuously monitoring the real-time data feeds from the various systems, the system may be configured to update the account information associated with the finances of multiple users, as described herein.

Moreover, it should be understood that the process flows described herein include transforming the retrieved data from the different systems (e.g., internally or externally) from the data format of the various systems to a data format associated with the life event application for display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

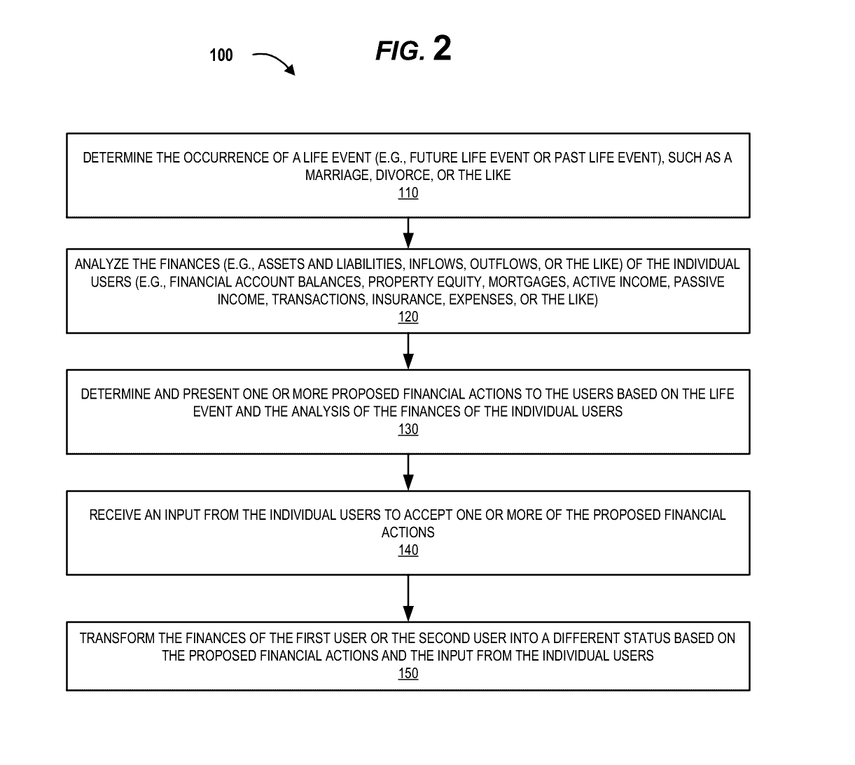

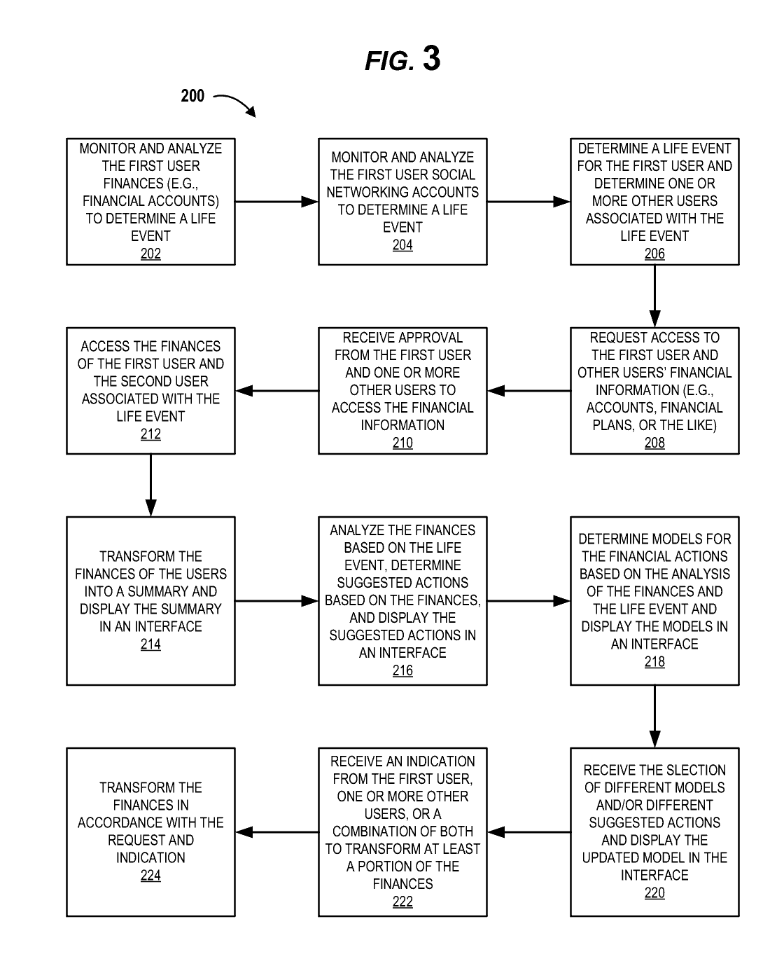

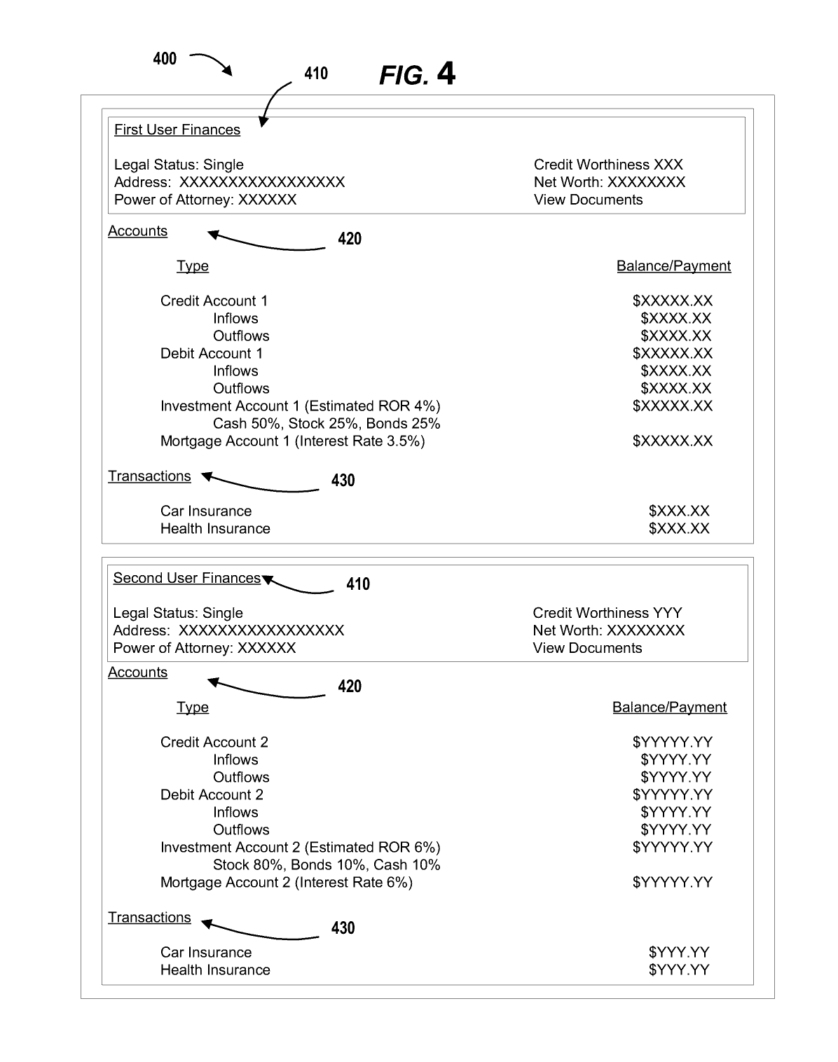

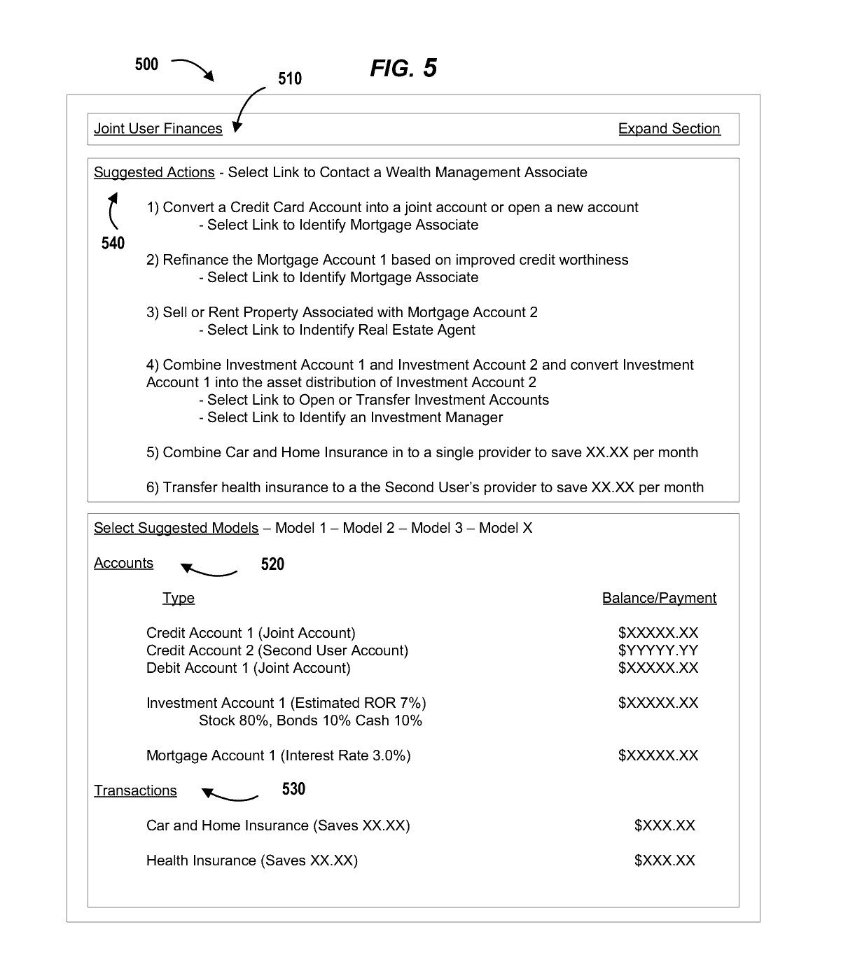

FIG. 2 illustrates a high level process flow for a life event financial planning process 100, in accordance with one embodiment of the invention. As illustrated by block 110 in FIG. 2, a determination of the occurrence of a life event is made. The life-event may be an event that has occurred in the past, but more typically the life event is a life-event that may occur in the future. Typically, the life event may be a marriage, a separation, a divorce, co-habitation or living apart, birth of a child, a child going to college, retirement of the user, or the like. The occurrence of a life event may be determined by the transactions that users make, social network postings made by users 4, 6, input into an application made by users 4, 6, or like as will be discussed in further detail later. FIG. 2 further illustrates that after the determination of an occurrence of a life event, the finances of the users 4, 6 associated with the life event are analyzed, as illustrated by block 120. As will be discussed in further detail later the analysis of the finances of the users 4, 6 may include analyzing the assets, liabilities, inflow, outflows, or the like of the users 4, 6 associated with the life event. A summary of the analyzed finances of the user 4, 6 may be displayed to the users 4, 6, in one or more life event interfaces (e.g., the life event interface 400 that both users may access, or the like). Block 130 of FIG. 2, illustrates that after the analysis of the finances, one or more suggested financial actions (also described herein as proposed financial actions or recommended financial actions) are determined and presented to the users 4, 6, as will be discussed in further detail later. For example, if it is determined that a first user 4 and second user 6 are planning on marrying, the proposed financial action may be suggesting to open a joint checking and savings account for the users 4, 6, convert the first user's checking account to a joint account, change the beneficiary on an account or life insurance policy to the second user 6, combine the car insurance payments of both users 4, 6, refinance the first user's home to receive a lower interest rate base on the improved credit rating of the second user 6, recommend renting instead of selling the second user's home, or other like financial action. The proposed financial actions are presented to the users in one or more life even interfaces (e.g., a recommended financial action interface that both users may access, or the like). FIG. 2 further illustrates in block 140, receiving an input from the users 4, 6 to take one or more of the proposed financial actions. Block 150 illustrates that after receiving the input from the users 4, 6, one or more of the proposed financial actions are automatically initiated, such as transforming the financial accounts into a different types of accounts, providing a new insurance plan for the user, transferring funds from savings accounts of both users into investments accounts, or the like. The life event financial planning process 100 discussed with respect to FIG. 2, will be described in further detail and with additional examples in the processes illustrated in FIG. 3, and the example life event interfaces illustrated in FIGS. 4 and 5.

FIG. 3 illustrates a life event process 200 in accordance with one embodiment of the invention. As illustrated by block 202 of FIG. 3, in order to determine if a life event has occurred with respect to a user (e.g., a first user), the system may monitor and analyze the user's financial accounts. The financial accounts may be monitored and analyzed in order to determine if the user 4, 6 has changed user profile information or entered into transactions that would indicated a change in a life event. For example, in one embodiment of the invention a user 4, 6, may change the status of a user's profile information to reflect that the user 4, 6, is married or single (e.g., divorced). In other embodiments, the user 4, 6 may change user profile information indicating that the user is having a child, or that the child is moving out of the house (e.g., adding a dependent or removing a dependent from financial planning documents, or the like). In other embodiments, the system may analyze the user's transactions, which may indicate that the user has undergone or is planning to undergo a life event change. For example, the user 4, 6 may enter into transactions for a florist, an event site, purchase a diamond ring indicating future engagement, purchase a home with another user, or enter into any other type of financial transaction that may indicate that the user 4, 6 is getting married. Alternatively, the user 4, 6 may purchase a house without the other user 4, 6, put a deposit down for a rental property, pay an attorney, or enter into any other type of financial transaction that may indicate that the user 4, 6 may be separating from or divorcing the other user 4, 6. In some embodiments of the invention, the user 4, 6, may be entering into a transaction for a crib, baby toys, diapers, or other like financial transactions that indicate that the user 4, 6 may be having a child with another user 4, 6. In still other embodiments, the user 4, 6 may enter into a financial transaction related to paying college tuition, paying application fees, or the like indicating that the user's child may be entering college. It should be understood that any type of transaction may be analyzed to determine if the user has, or will in the future, undergo a life event. In other embodiments the user 4, 6 may simply indicate to the system that the user is going to have a life event (e.g., select from a dropdown, enter text, or the like that the user is getting married, or the like).

Block 204 of FIG. 3 illustrates that user's social networking accounts may be analyzed for an indication that the user 4, 6 has undergone, or will undergo in the future, a life event. In one embodiment, the user's social networking accounts may be public, and as such, the system (e.g., the financial institution systems, or the like) may be able to monitor the user's social networking accounts for indications that the user 4, 6 has, or is planning on, undergoing a life event. In other embodiments, the user 4, 6 may provide the system (e.g., the financial institution system, or the like) the user's login name and password in order to allow the system to monitor one or more of the user's social networking accounts for indications of life events or for other financial reasons. For example, the user's may update the user's status, update the user's profile, post a status message, post a video, comment on a social networking site of another user 4, 6, send or receive a message within the account, or the like, which may indicate that the users 4, 6 are getting engaged, married, or divorced, going to school, having a baby, having a child go to school, having a child move out of the house, or undergoing any other potential life event.

In some embodiments, the life event may be automatically determined by the system based on the changes to the user information, the transactions, and/or the social media information. However, in some embodiments, if the system determines that the users 4, 6 have undergone, or will undergo, a life event, the system may prompt the users 4, 6 to confirm that the users 4, 6 have in fact, or will in future, undergo the determined life event. The users 4, 6 may then provide a response regarding whether or not the life event detected is correct (e.g., confirm engagement, marriage, separation, divorce, or the like).

As illustrated by block 206 of FIG. 3, a determination of the life event is made based on blocks 202 and/or 204, other input from the user, or the like. Moreover, if the life event is identified as being associated with a first user 4, the system will determine the one or more other users (e.g., second user 6, or the like) associated with the life event. The system may be able to determine the second user 6 (and/or additional users) by identifying the partner or child of the first user 4 by analyzing the user profile information (e.g., financial account or social networking account profile information). For example, the financial accounts of the first user 6 may indicate the name and/or other identifying information (e.g., user ID, SSN, address, account number, or the like) that indicates the identity of the second user 6 or other users directly (e.g., beneficiary of the account is the spouse and the spouse's name is listed, joint account holder associated with the account, transfers are made to someone listed as a spouse, or the like). Alternatively, identifying information can be compared with other accounts at the financial institution that has the same identifying information (e.g., address of the first user 4 is the same as the address of a second user 6 of a different account, the first user 4 is listed as a spouse beneficiary of an account of the second user 6, or the like).

In another example, the social networking account may list the family of the first user 6, which includes the second user 6 as a spouse or a child. In another example, a specific post in a social networking account may point to the second user 6 (e.g., the second user is tagged, or listed in a post, or the like) as being associated with a life event. For example, a post may indicate that the first user 4 is engaged to or is going to marry the second user 6. In some embodiments, the name of the second user 6 is not included in the social networking post, but the identity of the second user 6 may be determined from facial recognition of an image associated with the social networking activity (e.g., photo posted that includes the second user 6).

In other embodiments, the first user 4 may input the identity of the second user 6 or other users associated with a life event directly into a life event application 17, and/or provide a confirmation of the second user 6 or other users 6 after being prompted by the system.

After the determination of the life event and a second user 6 that is associated with the life event of the first user 6, a request to access the first user's and/or second user's financial accounts may be sent to the first user 4 and/or the second user 6, as illustrated by block 208. In some situations the first user 4 and the second 6 may need to confirm that they are part of the life event and want their finances analyzed and/or allow access to the user's financial accounts within or outside of the financial institution. For example, the first user 4 and the second user 6 may both have accounts with the financial institution, and as such the system (e.g., the financial institution system) may access the accounts of the first user 4 and second user 6 after specifically requesting access from the first user 4 and/or the second user 6. In other embodiments, the system may already have approval and/or access to the financial accounts of the users 4, 6, and as such the request for access is not needed. In other embodiments, the first user 4 and/or the second user 6 may have one or more financial accounts (or all financial accounts) with another financial institution, and as such the users 4, 6, may be prompted for login information (e.g., user name and password, or the like) to access the finances of the users 4, 6 at the other financial institutions.

As illustrated by block 210 in FIG. 3, after making the request for access to the finances of the users 4, 6, the system may receive approval from the first user 4 and/or second user 6 (or other users) to access the financial information of the users 4, 6 and/or to analyze the finances of the users 4, 6 in light of the life event.

Block 212 of FIG. 3 illustrates that the system (e.g., financial institution system, or the like) analyzes the finances of the first user 4 and the second user 6. The analysis may be made to create a summary of the user financial accounts before the life event occurs so that the users 4, 6 may take preemptive actions. For example, the system may give advice regarding pre-nuptial arrangements and how to classify both personal property and marital property, which may be selected and stored within the system. Alternatively, the analysis may be made to create a summary of the user financial accounts after the life event occurs so that the users 4, 6 can identify issues in their finances after the life event occurs. For example, the system may be used to suggested financial actions after the life occurs (e.g., a new house purchase should be in one user's name because the user has better credit worthiness).

Based on the analysis of the user's financial accounts, the system may transform the finances of the first user 4 and the second user 6 into a summary that illustrates important financial accounts and/or transactions of the users 4, 6, as illustrated by block 214 of FIG. 3. Block 214 further illustrates that the summary may be displayed in one or more life event interfaces that that may be displayed to, or accessed by, both the first user 4 and second user 6. In one example, the life event interface may display the joint accounts and single accounts owned by the first user 4 and the second 6 in order to help facilitate a separation or a divorce between the first user 4 and the second user 6. Alternatively, the life event interface may display the accounts and important transactions of the first user 4 and second user 6 side by side in order to facilitate discussions related to how the first user 4 and second user 6 want to manage finances after the users 4, 6 marry. It should be understood that the interfaces discussed herein may be displayed through an application that the users 4, 6 may both access. However, in some embodiments the interface with the account summary and/or the suggested financial actions (discussed below) may be displayed within online banking accounts of each of the users. For example, the online banking accounts of a first user 4 and a second user 6 may have a shared interface that both users 4, 6 can access, but the rest of the interfaces within each separate online banking account can only be accessed by the individual users.

One example of the life event interface is illustrated in FIG. 4, in which finances related to a life event for a first user 4 and a second user 6 are illustrated. The life event user finances interface 400 may include a user profile section 410, a user account section 420, and a user transaction section 430. In some embodiments, the user profile section 410 may include information about the users 4, 6, such as but not limited to legal status, address, power of attorney, credit worthiness, net worth, documents associated with the user finances, or the like. The user account section 420 may list the accounts owned by the users 4, 6, the balances of the accounts, the rates of return of the accounts, the interest rates on the accounts, or other like financial data related to the financial accounts of the users 4, 6. The transaction section 430 may list types of transactions that may relate to the finances of the users 4, 6, such as but not limited to insurance payments for various types of insurance policies, mortgage payments, transfers of funds to dependents, car payments, or other like payments that may be related to household payments that could be important to share between the first user 4 and/or second user 6. Analyzing the finances of the first user 4 and second user 6, and transforming the finances (e.g., transforming the format of the data into a new format) into a summary for display to the users 4, 6 associated with the life event provides insight into the finances of each of the users 4, 6 before the life event occurs.

Block 216 illustrates that based on the finances of the first user 4 and the second user 6, the system may suggest financial actions to the first user 4 and/or the second user 6 to take with respect to the finances of the users 4, 6.

In one typical example, if the life event is related to a first user 4 becoming engaged to or marrying the second user 6, then the system may identify from the finances of the first user 4 and the second user 6, that the users 4, 6 may want to take a number of actions, such as but not limited opening a new joint account or converting an existing account to joint ownership, refinancing the first user's or second user's mortgage based on an improved credit worthiness score of the other user, selling one of the homes or renting one of the homes owned by the users 4, 6, converting investment accounts into a single account and changing the account distribution to receive an improved rate of return, converting insurance payments to two different insurance companies into a single payment with one company (e.g., car insurance, health insurance, home insurance, or the like) to reduce costs, or recommending any other like financial action to reduce costs and improve returns for the users 4, 6.

In some embodiments the suggested financial actions may be displayed to the first user 4 and/or the second user 6 in a life event interface, such as a suggested financial action interface 500, as illustrated in FIG. 5 in one embodiment. The life event suggested financial action interface 500, like the life event user finances interface 400, may have a user profile section 510, a user account section 520, and a user transaction section 530, but may also include a suggested financial action section 540. With respect to the user profile section 510, this section may comprise an overview of the updated user profiles for both the first user 4 and the second user 6, as previously discussed with respect to the user profile section 410 described with respect to FIG. 4. The suggested financial action section 540 of the present invention may illustrate suggested actions along with links to contact associates from the financial institution if the users 4, 6 would like additional help. The suggested financial section 540 may also provide the results of the suggested financial actions to the users 4, 6, such as the combined balance of assets and liabilities, the monthly payments saved from a refinance, the reduction in the payments after combining resources (e.g., combining insurance companies), or the like. In other embodiments, the suggested financial section 540 may further allow for the selection of one or more of the suggested financial actions to include in an example model (not illustrated), and described in further detail below with respect to block 218.

In another example, if the life event is related to a first user 4 becoming separated and/or divorced from a second user 6, then the system may identify the joint assets of the users 4, 6 and suggest to the users 4, 6 how the accounts can be transformed and/or new accounts may be opened in order to create separate accounts for the user 4, 6. For example, the joint credit card account may be transferred into a single account for the first user 4 and a new credit card account may be opened for the second user 6, if applicable. In other examples, the results of the settlement agreement may be inputted into the life event application 17, and the system determines what accounts should be created and how the assets and liabilities for the funds should be distributed based on the settlement agreement (e.g., capturing information from an image of the settlement agreement).

In another example, if the life event is related to the first user 4 and the second user 6 having a child, the suggested financial actions may include opening a college investment account, opening savings account, updating health insurance options to include the child, or the like.

In other examples, if the life event is related to the first user 4 and the second user 6 having a child that is going to college, suggestions may be made to downsize the home, create a dependent credit card account for the child, create a dependent debit card account, or the like for the child.

In other examples, the suggested financial actions that are presented to the users 4, 6 may relate to actions that should be taken before the life event occurs, as well as actions that should be taken after the life event occurs. In one embodiment, the life event is related to a first user 4 becoming engaged to a second user 6, but the wedding will not take place for another year. The present invention may make suggested financial actions for the first user 4 and/or the second user 6 both before marriage and after marriage. For example, the system may indicate that the first user's mortgage is in the name of the first user and a co-singer of the first user 4, and before the first user 4 is married, the first user 4 should transfer the title of the property and the mortgage solely into the name of the first user 4. In another example, if first user 4 is marrying a second user 6 who is in a much higher tax bracket, and the first user 4 is planning on selling investments in stocks in the next couple of years, the system may suggest to the first user 4 to sell the stocks in the current year because selling the stocks in the year the users are married may subject the stocks to taxation at a higher tax level.

In addition to making changes to the financial accounts of the users 4, 6 or creating new accounts the suggested financial actions may also include verifying and/or updating the beneficiaries of the accounts. The changes may be made automatically by the system based on a change in the legal status of the users 4, 6 (e.g., married, single, child dependent, or the like). For example, when the user 4, 6 gets married, the first user investment account beneficiary may automatically change to the second user 6, with or without prompting the first user 4 to confirm the change. In other embodiments, the users 4, 6 may be prompted to determine the beneficiaries for any current account, as well as any altered or new financial accounts suggested by the system.

As such, the present invention may be configured to present pre-event analysis of the finances of the users 4, 6 and display the suggestions to the users 4, 6, as well as present post-event analysis of the finances of the user 4, 6 and display the suggestions to the user 4, 6.

In addition to presenting the suggested financial actions as described with respect to block 216, or in the alternative, block 218 of FIG. 3 illustrates that based on the analysis of the user accounts, the system of the present invention may develop different models for the finances of the users 4, 6, and may display the proposed models to the user 4, 6. Different users presented with the same life event may like to take different actions with respect to the user finances. As such, the different models may provide different options related to how the users 4, 6 may want to adjust the users' finances based on the life event. For example, multiple model options may be presented to the first user 4 and/or the second user 6 for taking different combinations of the suggested financial actions. For example, model 1 may illustrate if the users 4, 6 implemented all of the suggested financial actions, while models 2, 3, 4, X, or the like may illustrate the results of taking one or more combinations of the suggested financial actions. In one example, as illustrated in the a user account section 520 and the user transaction section 530 of the suggested financial action interface 500 of FIG. 5, the user 4, 6 may be able to select various model options in order to view how different combinations of the selected suggested financial actions impact the finances of the users 4, 6. The user transactions section 530 may display the combined balances of the financial accounts of the users 4, 6, the changes to the investment accounts and the estimated rates of return of the account, the savings associated with refinancing the mortgage of the user, and the combined payments and savings for various transactions of the users 4, 6 after accepting one or more of the suggested financial actions.

Block 220 indicates that the user may select different models and/or different suggested financial actions in order to view different applications of the suggested financial actions. Each user 4, 6 may have the ability to view the combined finances (or the separated finances in the case of separation or divorce, or other views based on different life events) of the users 4, 6 and the various models associated with the finances. Moreover, in some embodiments, the suggested financial actions may be selected or deselected and the model may change in real time or near real-time to illustrate how the different selected suggested financial actions may change the finances of the users 4, 6. For example, in the suggested financial action section 540 the users 4, 6 may select or deselect the various suggested financial actions, and the model illustrated in the user account section 520 and user transaction section 530 will change based on the selected financial actions. This process allows the users 4, 6 to pick, choose, and test the various suggested financial actions that the users 4, 6 may want to eventually implement.

Block 222 in FIG. 3 illustrates that an indication is received from the first user 4, the second user 6, and/or a combination of both to implement one or more of the suggested financial actions or one of the models with one or more of the suggested financial actions. In some embodiments, both the first user 4 and the second user 6 have to provide the indication because the financial actions relate to financial accounts of both users 4, 6. In some embodiments, if authorization has been previously provided by the first user 4 and/or the second user 6, the suggested financial actions and/or the model may be automatically implemented. For example, if a joint account is being split into separate accounts, or funds from separate accounts are being combined into a single account, the users 4, 6 of all of the accounts may need to confirm the financial action (e.g., approve the account alternation or opening of a new account, or the like). In other embodiments, verification may require authentication of the users 4, 6. As such, if the first user 4 and/or the second user 6 has not been authenticated, authentication requests may be sent and/or received by the various users 4, 6, associated with the financial action occurring based on the life event.

Block 224 illustrates that the system (e.g., the financial institution system, or the like) transforms the finances of the first user 4 and the second user 6 in accordance with the indication received from the first user 4, the second user 6, and/or a combination of both. The system of the present invention may send a request to each of the business units within the financial institution and/or the third-parties (e.g., for products not offered by the financial institution) through the account applications 54 to allow the business units to make the changes to the financial accounts of the user 4, 6 at the same time with a single request. For the accounts that are not with the financial institution (e.g., transaction payments to insurance companies, accounts at other financial institutions), the system may direct the users 4, 6 to contacts at the third-parties. However, in some embodiments the financial institution may provide a substitute service or product for the users 4, 6. For example, the financial institution may provide a quote from a partner company for an insurance product, or a request to open a new type of product.

As such, the system allows the users 4, 6 to make any financial changes to the finances of the users 4, 6 without each user 4, 6 having to individually request the changes independently, and without having to contact multiple associates from different areas within the financial institution to request the financial account changes. The present invention simplifies the time consuming and intensive process of making changes to the user's accounts before or after the occurrence of the life event.

In some embodiments, the selected suggested financial actions and/or models may be made before the life event, but not take effect until after the occurrence of the life event. As such the financial changes may be approved, but may be specifically scheduled to take place at a future time period, on the day of or after the occurrence of the life event. In other embodiments, after approving a plurality of suggested financial actions, the actions may be implemented immediately, before the occurrence of the life event and/or after the occurrence of the life event.

In some embodiments, in order for the system to take a requested financial action, the system may need additional information from the users 4, 6, and as such, the system may determine the financial action information needed to complete the selected financial action. In some embodiments the financial action information may include legal status information related to the relationship between the users 4, 6 associated with the life event, information needed to open accounts, pay stubs, account statements, or other like information. For example, in some embodiments, such as for opening a new joint account, the financial action information required may be a marriage certificate, a user signature card, or the like. In other embodiments, such as for refinancing a mortgage of one of the users 4, 6 the financial action information may include pay stubs, account statements, tax records, or the like. In other embodiments, in order to remove a user 4, 6 from a joint account or take other actions with respect to splitting up assets, a certificate of divorce and/or a copy of the settlement agreement or court ordered agreement may be required.

When additional information is required for the system to take a requested financial action, the system may send a request to the users 4, 6 for the financial action information associated with the financial action. The request for the financial action may be sent to the users 4, 6 through the life event application 17, the online banking applications 52 of the users 4, 6, and/or other applications. Alternatively, the request may be sent through e-mail, pop-up screens, text message, application messenger, or the like.

The financial action information is received by the system, and the financial action information may be extracted. In some embodiments, the financial action information may include images of documents, such as but not limited a marriage certificate, signature sample, settlement agreement, court ordered agreement, images of pay stubs, account statements, images of answers to questions regarding the financial action, or other like images. In other embodiments of the invention, the financial action information may be received through electronic text response to the request or the selection of pre-supplied answers. The system may extract the financial action information received from the users 4, 6. In some embodiments this includes analyzing the text information received. In other embodiments, this includes pulling information from the images received, for example pulling information from the image of the marriage certificate, divorce certificate, and/or other images. For example, the date of the marriage certificate, divorce certificate, court order settlement agreement, or the like may be captured from the image, and thus indicate the occurrence of a life event and the date on which the event will or did occur. Additionally, the name of the partner (or other second user 6) in the certificate may be captured from the image and illustrates the second user 6 associated with the life event of the first user 4.

After receiving the additional information the system completes the altering, consolidating, or opening of accounts based on the life events and the request received from the users 4, 6 by automatically transforming the accounts of the user 4, 6 or providing other information through links, or the like as previously described with respect to block 224 in FIG. 3.

In some examples, a financial action may not become official until the life event actually occurs (e.g., until the users 4, 6, marry, get divorced, have a child, or the like). In some embodiments, the system may prompt the users 4, 6 for additional information. As such, while an account may be set up, the account may not become active, a beneficiary may not be changed, a power of attorney may not become official or the like, unless confirmation is received from the user 4, 6 that the life event occurred. For example, the system may prompt the users 4, 6 to verify that the users were married, divorced, had a child, or the like, after a scheduled life event occurs. Moreover, in addition to the financial actions that he user did take, the system may continue to evaluate the user's finances and provide additional prompts over time. For example, the system may recognize that after becoming married the users 4, 6 still have not opened a joint account, and thus may prompt the users after a period of time if the users 4, 6 would like to open a joint account.

In some embodiments of the invention, the users 4, 6 and/or the financial institution may place restrictions on how the finances may be changed or how different accounts may be funded. For example, in one example, a spouse may place restrictions on a personal account, indicating that the funds for the account are individual property and not marital property, and as such, the funds should not be used for martial purposes. In some cases, when funds are used from an account with a particular designation (e.g., individual account, marital account, parental account, guardian account, or the like) the use of the funds may be restricted (e.g., individual funds cannot be transferred to a marital account). In some embodiments, a notification may be presented to the user (e.g., a notification a mobile phone being used for a transaction) that the account being used for a particular transactions has a designation to only use the funds for particular transactions. In other embodiments, the designation may prevent the user 4 from entering into a transaction, such as transferring assets from a designated individual account to a marital property account. The system may send out notifications (e.g., a text alert, or the like) when an account is being used for a particular transaction.

It should be understood that the examples described herein generally relate to life events related to two users (e.g., a first and second users 4, 6 getting married); however, it should be understood that life events that relate to multiple users may also be applicable. For example, spouses with children or parents either living with them or leaving the home, may result in changes in the finances of the spouses based changes in the living situations of the children or parents of the spouses. In one embodiment, the bills of the spouses may go up or down based on having to support children or parents.

As previously discussed, the interfaces through which the users 4, 6 may view the analysis of the user finances, before and after the invention, may be displayed through the online banking account(s) of the one or more users 4, 6. However, in some embodiments, the results of the analysis of the user finances and suggested financial actions may be exportable to other users. For example, spouses may export, or otherwise allow, children or parents to view, access, or use the analysis of finances and the suggested financial actions of the spouses. In one embodiment, the children may be able to access an interface illustrating the analysis of the finances and the suggested financial actions of the spouses (e.g., before or after the event). In other embodiments, the analysis of the finances and the suggested financial actions may be exported to other entities, applications, users, or the like. In still other embodiments, the information related to the analysis of the finances and the suggested financial actions may be exported to, or otherwise accessed, by financial advisors or attorneys for additional analysis or in order to take actions based on the information.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | | | |
|---|---|---|---|
| | U.S. patent application | | |
| Docket Number | Ser. No. | Title | Filed On |

| | | |
|---|---|---|
| 6810US1.014033.2511 | SYSTEM FOR | Concurrently |
| | RESTRUCTURING BASED ON | Herewith |
| | PREDICTIVE ANALYSIS | |
| 6811US1.014033.2512 | UNIVERSAL TOKENIZATION | Concurrently |
| | SYSTEM | Herewith |
| 6812US1.014033.2513 | SYSTEM FOR MODELING | Concurrently |
| | AND IMPLEMENTING EVENT- | Herewith |
| | RESPONSIVE RESOURCE | |
| | ALLOCATION STRUCTURES | |
| 6813US1.014033.2514 | SYSTEM FOR SIMULATION | Concurrently |
| | AND IMPLEMENTATION OF | Herewith |
| | DYNAMIC STATE- | |
| | DEPENDENT RESOURCE | |
| | RECONFIGURATION | |
| 6815US1.014033.2515 | SYSTEM FOR DYNAMIC | Concurrently |
| | VISUALIZATION OF | Herewith |
| | INDIVIDUALIZED | |
| | CONSUMPTION ACROSS | |
| | SHARED RESOURCE | |
| | ALLOCATION STRUCTURE | |
| 6817US1.014033.2516 | SYSTEM FOR ANALYZING | Concurrently |
| | PRE-EVENT AND POST- | Herewith |
| | EVENT INDIVIDUAL | |
| | ACCOUNTS AND | |
| | TRANSFORMING THE | |
| | ACCOUNTS | |

What is claimed is:

1. A system for providing recommended financial actions for finances of users based on life events of the users, the system comprising:
one or more memory devices having computer readable program code store thereon; and
one or more processing devices operatively coupled to the one or more memory devices, wherein the one or more processing devices are configured to execute the computer readable program code to:
determine a life event occurrence, wherein the life event may include a past life event or a future life event;
determine a second user associated with the life event of the first user;
access financial accounts of the first user and the second user associated with the life event, through the financial institution systems or third-party systems;
analyze the finances of the first user and the second user from the financial accounts;
determine suggested financial actions for the first user and the second user, wherein the suggested financial actions comprise pre-event financial actions or post-event financial actions;
display the suggested financial actions to the first user and the second user in a user interface, through the first user computer system and the second user computer system;
receive an indication from the first user and the second user to take at least one suggested financial action from the suggested financial actions, wherein the at least one suggested financial action comprises transforming at least one financial account from the financial accounts into a different account type or creating a new financial account and transferring the assets of at least one of the financial accounts of the first user or the second user into the new account; and
apply the suggested financial action, wherein applying the suggested financial action comprises automatically transforming the at least one financial account into the different account type or creating the new financial account and transferring the assets of at least one of the financial accounts of the first user or the second user into the new financial account.

2. The system of claim 1, wherein the life event comprises a marriage or a divorce between the first user and the second user.

3. The system of claim 2, wherein the one or more processing devices are further configured to execute the computer readable program code to:
receive an image of a certificate of marriage or certificate of divorce; and
capture information from the image, wherein the captured image indicates the occurrence of the life event or indicates the second user associated with the life event.

4. The system of claim 1, wherein the one or more processing devices are further configured to execute the computer readable program code to:
prompt the first user to verify that the life event occurred;
receive conformation from the first user that the life event occurred; and
wherein applying the suggested financial action occurs after the life event has been verified.

5. The system of claim 2, wherein the one or more processing devices are further configured to execute the computer readable program code to:
automatically designate the second user as a beneficiary of the financial accounts of the first user when the life event is the marriage, or automatically remove the second user as the beneficiary of the financial accounts of the first user when the life event is the divorce.

6. The system of claim 1, wherein the one or more processing devices are further configured to execute the computer readable program code to:
automatically designate the second user for power of attorney when the life event is the marriage or automatically remove the second user for power of attorney when the life event is the divorce.

7. The system of claim 1, wherein the one or more processing devices are further configured to execute the computer readable program code to:
monitor if the first user and the second user applied the suggested financial actions over a time period; and
prompt the first user or the second user to apply another suggested financial action.

8. The system of claim 1, wherein the determination of the life event comprises:
monitoring transaction information of the first user account through the financial institution systems; and
identifying the transaction information indicating the life event.

9. The system of claim 1, wherein the determination of the life event comprises:
monitoring social networking information from a user social networking account of the first user, through the social networking systems; and
identifying social networking information indicating the life event.

10. The system of claim 1, wherein the one or more processing devices are further configured to execute the computer readable program code to:
create a plurality of financial models, wherein each of the plurality of financial models comprise different combinations of the suggested financial actions;
wherein displaying the suggested financial actions comprises displaying the plurality of financial models in the one or more interfaces; and
receive a selection of one of the plurality of financial models from the first user or the second user to implement.

11. The system of claim 1, wherein the one or more processing devices are further configured to execute the computer readable program code to:
receive a selection of a plurality of financial actions from the suggested financial actions to implement;
determine a financial model based on the selection of the plurality of financial actions and display the financial model in the one or more interfaces to the first user and the second user.

12. The system of claim 1, wherein the suggested financial actions are suggested financial actions to take before the occurrence of the life event.

13. The system of claim 1, wherein the suggested financial actions are suggested financial actions to take after the occurrence of the life event.

14. The system of claim 1, wherein the one or more processing devices are further configured to execute the computer readable program code to:
request access to the financial accounts of the first user and the second user; and
receive allowance from the first user and the second user to access the financial accounts of the first user and the second user at other financial institutions.

15. The computer implemented method for providing recommended financial actions for finances of users based on life events of the users, the system comprising:
determining, by one or more processing devices, a life event occurrence, wherein the life event may include a past life event or a future life event;
determining, by the one or more processing devices, a second user associated with the life event of the first user;
accessing, by the one or more processing devices, financial accounts of the first user and the second user associated with the life event, through the financial institution systems or third-party systems;
analyzing, by the one or more processing devices, the finances of the first user and the second user from the financial accounts;
determining, by the one or more processing devices, suggested financial actions for the first user and the second user, wherein the suggested financial actions comprise pre-event financial actions or post-event financial actions;
displaying, by the one or more processing devices, the suggested financial actions to the first user and the second user in a user interface, through the first user computer system and the second user computer system;
receiving, by the one or more processing devices, an indication from the first user and the second user to take at least one suggested financial action from the suggested financial actions, wherein the at least one suggested financial action comprises transforming at least one financial account from the financial accounts into a different account type or creating a new financial account and transferring the assets of at least one of the financial accounts of the first user or the second user into the new account; and
applying, by the one or more processing devices, the suggested financial action, wherein applying the suggested financial action comprises automatically transforming the at least one financial account into the different account type or creating the new financial account and transferring the assets of at least one of the financial accounts of the first user or the second user into the new financial account.

16. The method of claim 15, wherein the life event comprises a marriage or a divorce between the first user and the second user.

17. The method of claim 15, further comprising:
receiving, by the one or more processing devices, an image of a certificate of marriage or certificate of divorce;
capturing, by the one or more processing devices, information from the image, wherein the captured image indicates the occurrence of the life event or indicates the second user associated with the life event.

18. The method of claim 15, further comprising:
prompting, by the one or more processing devices, the first user to verify that the life event occurred;
receiving, by the one or more processing devices, conformation from the first user that the life event occurred; and
wherein applying the suggested financial action occurs after the life event has been verified.

19. The method of claim 15, further comprising:
monitoring, by the one or more processing devices, social networking information from a user social networking account of the first user, through the social networking systems; and
identifying, by the one or more processing devices, social networking information indicating the life event.

20. The method of claim 15, further comprising;
creating, by the one or more processing devices, a plurality of financial models, wherein each of the plurality of financial models comprise different combinations of the suggested financial actions;
wherein displaying the suggested financial actions comprises displaying the plurality of financial models in the one or more interfaces; and
receiving, by the one or more processing devices, a selection of one of the plurality of financial models from the first user or the second user to implement.

21. A computer program product for providing recommended financial actions for finances of users based on life events of the users, the computer program product comprising at least one non-transitory computer-readable medium having computer-readable program code portions embodied therein, the computer-readable program code portions comprising:
an executable portion configured to determine a life event occurrence, wherein the life event may include a past life event or a future life event;
an executable portion configured to determine a second user associated with the life event of the first user;
an executable portion configured to access financial accounts of the first user and the second user associated with the life event, through the financial institution systems or third-party systems;
an executable portion configured to analyze the finances of the first user and the second user from the financial accounts;
an executable portion configured to determine suggested financial actions for the first user and the second user, wherein the suggested financial actions comprise pre-event financial actions or post-event financial actions;
an executable portion configured to display the suggested financial actions to the first user and the second user in a user interface, through the first user computer system and the second user computer system;
an executable portion configured to receive an indication from the first user and the second user to take at least one suggested financial action from the suggested financial actions, wherein the at least one suggested financial action comprises transforming at least one financial account from the financial accounts into a different account type or creating a new financial account and transferring the assets of at least one of the financial accounts of the first user or the second user into the new account; and
an executable portion configured to apply the suggested financial action, wherein applying the suggested financial action comprises automatically transforming the at least one financial account into the different account type or creating the new financial account and transferring the assets of at least one of the financial accounts of the first user or the second user into the new financial account.
